(19) United States
(12) Patent Application Publication
(10) Pub. No.: US 2010/0124226 A1
(43) Pub. Date: May 20, 2010

(54) ELECTRONIC DATA TRANSMITTING APPARATUS

(75) Inventor: Yukio Matsuda, Osaka (JP)

Correspondence Address: EDWARDS ANGELL PALMER & DODGE LLP, P.O. BOX 55874, BOSTON, MA, 02205, US

(73) Assignee: SHARP KABUSHIKI KAISHA, Osaka (JP)

(21) Appl. No.: 12/617,144

(22) Filed: Nov. 12, 2009

(30) Foreign Application Priority Data
Nov. 14, 2008 (JP) 2008-291965

(51) Int. Cl. H04L 12/56

(52) U.S. Cl. 370/390

(57) ABSTRACT

An electronic data transmitting apparatus is provided, which is capable of determining a transmission method for each address in accordance with the attribute of each address (receiver), such as a title or a position. When a user specifies addresses A to F and instructs the electronic data transmitting apparatus of the present invention to transmit electronic data with a security level (confidential levels A to C, confidential level zero) set thereon via multi-casting to each address, the transmitting device refers to an address attribute information table and a transmission rule table and determines a transmission method of electronic data, as shown on a transmission table of FIG. 1C.

### CROSS-NOTING PARAGRAPH

This non-provisional application claims priority under 35 U.S.C. §119(a) on Patent Application No. 2008-291965 filed in JAPAN on Nov. 14, 2008, the entire contents of which are hereby incorporated herein by reference.

### FIELD OF THE INVENTION

The present invention relates to an electronic data transmitting apparatus having a function of transmitting electronic data via multi-casting.

### BACKGROUND OF THE INVENTION

Various electronic data transmitting apparatuses capable of transmitting electronic data via multi-casting, such as an IP fax, have been proposed. By using a method disclosed in Japanese Laid-Open Patent Publication No. 2001-333246, a transmission method can be determined for each address when multi-casting of electronic data is carried out.

For example, when electronic data is transmitted to an address A, if it is determined to set permission of printing in the electronic data as additional information and the electronic data is transmitted based on a determined transmission method, a receiver (address A) who receives the electronic data is able to print the electronic data. When electronic data is transmitted to an address B, if it is determined to set nonpermission of printing in the electronic data is determined as additional information and the electronic data is transmitted based on a determined transmission method, a receiver (address B) who receives the electronic data is not able to print the electronic data.

When electronic data is transmitted to a lot of employees via multi-casting in a company, etc., it is difficult to determine a transmission method for each address as described above manner.

For example, a case of transmitting company confidential electronic data via multi-casting to regular employees and temporary staff is assumed. In this case, to prevent information leak, when the electronic data is transmitted to manager or higher ranked staff, additional information of permission of printing is set in the electronic data and then the electronic data is transmitted. When the electronic data is transmitted to other employees or temporary staff, it is necessary to set additional information of nonpermission of printing in the electronic data and then transmit the electronic data.

In such a case, if a conventional electronic data transmitting apparatus is used, a sender of the electronic data must determine a transmission method for each address, which is extremely troublesome work.

### SUMMARY OF THE INVENTION

An object of the present invention is to provide an electronic data transmitting apparatus capable of determining a transmission method for each address in accordance with the attribute of the address (receiver), such as a title or a position.

Another object of the present invention is to provide an electronic data transmitting apparatus having a function of multi-casting electronic data to each address comprising an address information recording table having a record of attribute information of the address for each address; a transmission rule table having a record of a transmission rule for the electronic data in association with the attribute information of the address, and attribute information preset to the electronic data; and a transmission method determining portion that determines a transmission method for electronic data by referring to the attribute information preset to the electronic data, the address information recording table, and the transmission rule table, when the electronic data is transmitted to any of addresses recorded on the address information recording table via multi-casting, wherein the electronic data is transmitted via multi-casting based on the determined transmission method.

Yet another object of the present invention is to provide the electronic data transmitting apparatus comprising: a server device that stores the electronic data and allows a user to browse the electronic data upon receiving a browsing request from the user; and a recording portion that records information of a place of storage of the electronic data stored in the server device, wherein when the transmission method determining portion determines Web browsing as a transmission method of electronic data for each address, the information of the place of storage of the electronic data is transmitted to each address instead of electronic data.

Still another object of the present invention is to provide the electronic data transmitting apparatus, wherein the server device has a document server function for storing therein all pieces of electronic data to be transmitted or a browsing server function for allowing a user to browse the electronic data to be transmitted in response to a browsing request from the user.

Yet still another object of the present invention is to provide the electronic data transmitting apparatus, wherein when the transmission method determining portion determines to provide additional information with the electronic data as a transmission method when transmitting the electronic data, the electronic data is transmitted with the determined additional information to each address via multi-casting.

Still yet another object of the present invention is to provide the electronic data transmitting apparatus wherein the additional information is a method of printing the electronic data.

A further object of the present invention is to provide the electronic data transmitting apparatus wherein the additional information is information of permission/nonpermission of editing the electronic data.

A yet further object of the present invention is to provide the electronic data transmitting apparatus wherein the electronic data is attached to an e-mail and the e-mail is transmitted to each address via multi-casting.

A still further object of the present invention is to provide the electronic data transmitting apparatus wherein information on the determined transmission method and the additional information are added to a text of the e-mail and the e-mail is transmitted to each address via multi-casting.

A yet still further object of the present invention is to provide the electronic data transmitting apparatus wherein the attribute information of the address is information of the present location of an electronic data receiver.

A still yet further object of the present invention is to provide an electronic data transmitting method executed by an electronic data transmitting apparatus having: an address information recording table having a record of attribute information of each address; a transmission rule table having a record of a transmission rule for the electronic data in association with the attribute information of the address for each address, and attribute information preset to the electronic data; and a function for multi-casting electronic data to each address, the method comprising steps of: when electronic data is transmitted via multi-casting to any of addresses recorded on the address information recording table, referring to the attribute information preset to the electronic data, the address information recording table, and the transmission rule table; determining a transmission method of the electronic data; and transmitting the electronic data to each address via multi-casting in accordance with the determined transmission method.

According to the present invention, a transmission method of electronic data to be transmitted to each address can be determined for each address depending on the attribute of the address (receiver), such as a title or a position. This improves convenience in performing transmission of electronic data.

### BRIEF DESCRIPTION OF THE DRAWINGS

FIGS. 1A to 1C show an example of an address attribute information table, an example of a transmission rule table, and an example of a transmission table, respectively;

FIG. 2 is a function block diagram of an electronic data transmitting apparatus and a browsing server device;

FIG. 3 is a flowchart for explaining the transmission method determining processing;

FIGS. 4A and 4B show another example of a transmission rule table and another example of a transmission table, respectively;

FIGS. 5A to 5C show an example of a transmission rule table, an example of a specifying table, and an example of a transmission table, respectively;

FIGS. 6A to 6C show another example of an address attribute information table, another example of a transmission rule table, and another example of a transmission table, respectively; and

FIGS. 7A to 7C show still another example of an address attribute information table, still another example of a transmission rule table, and still another example of a transmission table, respectively.

### PREFERRED EMBODIMENTS OF THE INVENTION

### First Embodiment

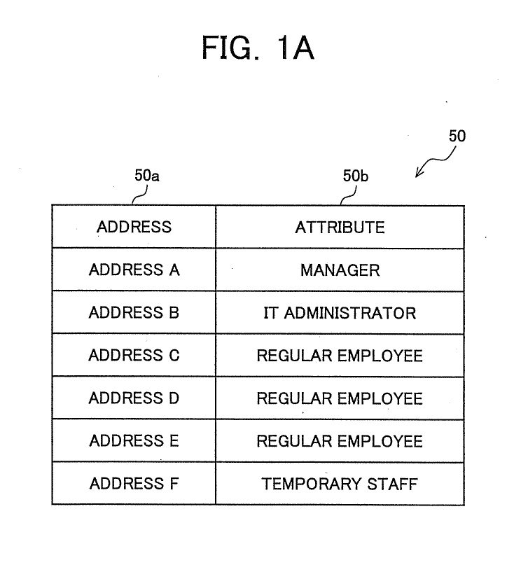

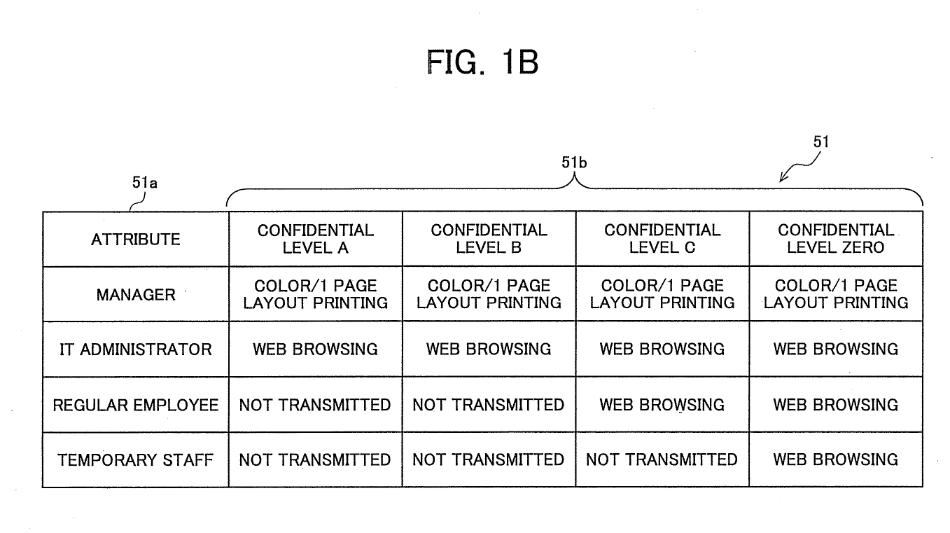

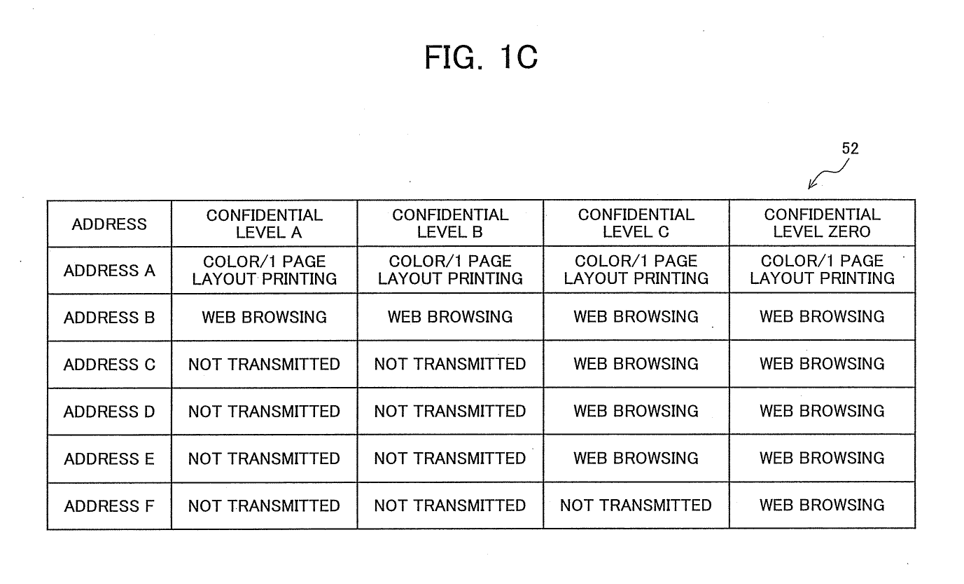

An electronic data transmitting apparatus of the present invention will now be described schematically with reference to FIGS. 1A to 10.

FIG. 1A shows an example of an address attribute information table (address information recording table) 50 containing a record of addresses representing the destination of transmission of electronic data and attribute information of each of the addresses.

Reference numeral 50a denotes an address column in which an address, such as a receiver's e-mail address, is recorded. Reference numeral 50b denotes an attribute information column in which attribute information of the address (receiver), for example, a title of the receiver, is recorded.

FIG. 1B shows an example of a transmission rule table 51 in which transmission rules for the electronic data is in association with the attribute information of the addresses and attribute information preset to the electronic data.

A column 51a contains attribute information of an address that is recorded in the attribute information column 50b of the address attribute information table 50.

A column 51b contains a transmission rule for electronic data in association with the attribute information of the electronic data, such as a security level, that is preset to the electronic data to be transmitted.

Examples of transmission rules include setting additional information of printing method, etc., (color/single(1)-page layout printing, etc.) in electronic data to be transmitted, transmitting a URL representing a place of storage of electronic data instead of transmitting the electronic data itself (Web browsing), and not transmitting electronic data (electronic data is not transmitted).

When a user specifies addresses A to F and instructs the electronic data transmitting apparatus of the present invention to transmit electronic data via multi-casting with a security level (confidential levels A to C, confidential level zero) set therein, the transmitting device refers to the address attribute information table 50 and the transmission rule table 51 to determine transmission methods of the electronic data, as shown in a transmission table 52 of FIG. 10.

For example, when the transmitting device transmits electronic data which a confidential level C is set as attribute information to an address A (a manager), the transmitting device sets a printing method, such as “color/single(1)-page layout printing” (permission of printing), as additional information in the electronic data and transmits the electronic data.

A receiver who receives the electronic data is thus able to print out the electronic data using the set printing method set by the transmitting device.

It is also possible to set editing permission/nonpermission information which includes permission/nonpermission of the editor by the receiver who receives the electronic data.

A receiver who received the electronic data with additional information of permitting edition set therein is allowed to edit the electronic data, but a receiver who received electronic data with additional information of not permitting edition (nonpermission of editing) set therein is not allowed to edit the electronic data.

In this manner, the editing authority of a receiver (address) can be set based on attribute information of the address. Since this allows only the specific receiver to edit electronic data, tampering of electronic data can be controlled.

When the same electronic data is transmitted to an IT administrator (address B) and regular employees (addresses C to E), the electronic data itself is not transmitted but an e-mail including the URL of a place of storage of the electronic data is transmitted.

The IT administrator who received the e-mail is able to browse information on the electronic data on a browser (Web browsing) by accessing the URL. When such information is browsed on the browser, the electronic data cannot be printed out (nonpermission of printing).

The electronic data and the URL of the place of storage of the electronic data are not transmitted to a temporary staff (address F).

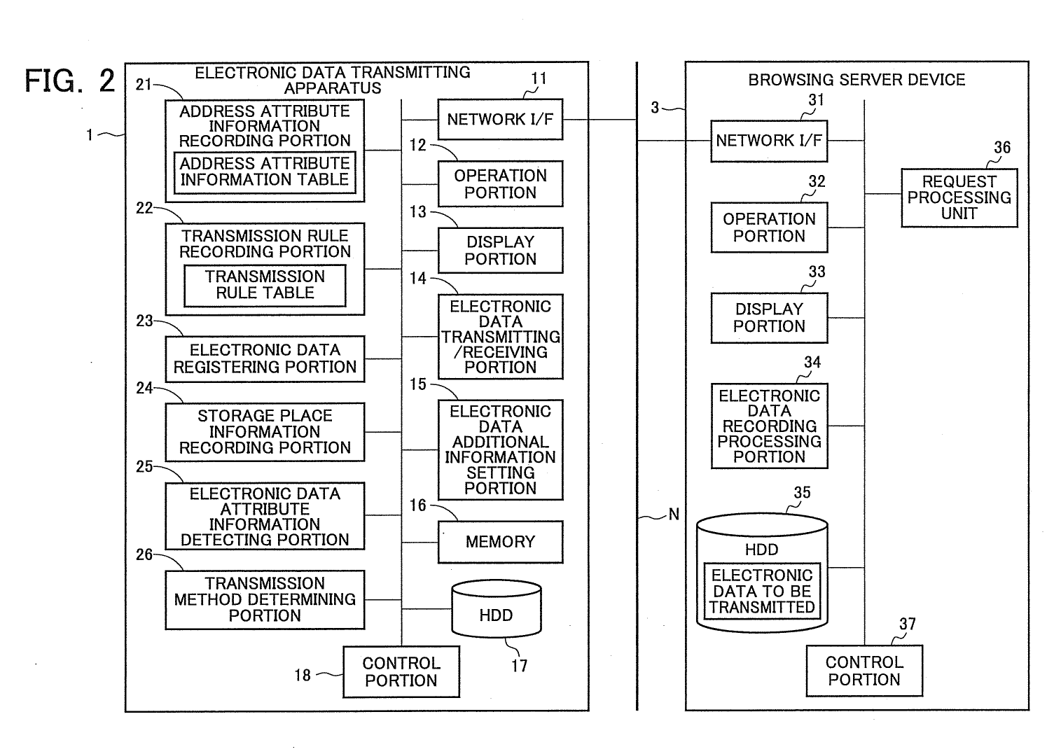

FIG. 2 is function block diagrams of the electronic data transmitting apparatus 1 and a browsing server device 3 of the present invention. The electronic data transmitting apparatus 1 and the browsing server device 3 are interconnected through a net work N.

### <Electronic Data Transmitting Apparatus 1>

The function blocks of the electronic data transmitting apparatus 1 will be described first.

The electronic data transmitting apparatus 1 can be incorporated in an information processing device such as an image forming device, IP facsimile, and PC.

Reference numeral 11 denotes a network I/F that provides an interface for connection to the network N, such as the Internet, reference numeral 12 denotes an operation portion composed of a numeric keypad, touch-panel, etc., and reference numeral 13 denotes a display portion that displays status information on the electronic data transmitting apparatus 1, etc.

Reference numeral 14 denotes an electronic data transmitting/receiving portion that transmits/receives electronic data in the form of an e-mail, etc. The electronic data transmitting/receiving portion encodes electronic data recorded on an HDD 17 in conformity with, for example, MIME (Multipurpose Internet Mail Extension) to create an e-mail massage (attach electronic data to an e-mail), and transmits the e-mail to an address that is specified by a user through an operation portion 12. As described above, the electronic data transmitting/receiving portion also creates an e-mail massage including the URL of a server having electronic data stored therein to transmit the e-mail to a specified address.

Reference numeral 15 denotes an electronic data additional information setting portion that sets additional information in electronic data recorded on the HDD 17. Examples of additional information include a printing method of color/monochrome printing, n-page layout printing, etc., and information of permission/nonpermission of editing, as described above.

Attribute information of a security level, etc., is set in advance in electronic data through the operation portion 12.

Reference numeral 16 denotes a memory that has various control information stored therein. The HDD 17 is a large-capacity recording unit that stores electronic data (electronic data to be transmitted), and the like, input to the electronic data transmitting apparatus 1 via the network N, etc.

The HDD 17 includes an address book that records names, titles, e-mail addresses, etc.

Reference numeral 18 denotes a control portion that controls each of the function blocks.

Reference numeral 21 denotes an address attribute information recording portion having an address attribution information table 50. The address attribute information recording portion 21 records an address (receiver) and attribute information of the address that are input through the operation portion 12, on the address attribution information table 50.

Reference numeral 22 denotes a transmission rule recording portion. The transmission rule recording portion 22 records attribute information of an address input through the operation portion 12 and a transmission rule for electronic data to be transmitted, on a transmission rule table 51.

Reference numeral 23 denotes an electronic data registering portion. The electronic data registering portion outputs electronic data (electronic data to be transmitted) for Web browsing to the browsing server device 3 and registers the electronic data in (stores the electronic data in) the browsing server device 3.

Reference numeral 24 denotes a storage place information recoding portion. The storage place information recoding portion 24 records storage place information (URL) of the data to be transmitted stored in the browsing server device 3.

Reference numeral 25 denotes an electronic data attribute information detecting portion. The electronic data attribute information detecting portion 25 detects attribute information preset in electronic data, for example, a security level.

Reference numeral 26 denotes a transmission method determining portion. When electronic data is transmitted via multi-casting to any of addresses recorded on the address attribute information table 50 the address attribute information table 50 and the transmission rule table 51 are referred and a transmission method of electronic data is determined for each address so as to accord with a transmission rule for each address (see FIG. 1C).

The electronic data transmitting/receiving portion 14 transmits the electronic data via multi-casting based on the determined transmission method.

### <Browsing Server Device 3>

The function blocks of the browsing server device 3 will be described. The browsing server device 3 has electronic data stored therein and allows a user to browse the electronic data when receiving a browsing request from the user.

Reference numeral 31 denotes a network I/F that provides an interface for connection to the network N, such as the Internet, reference numeral 32 denotes an operation portion composed of a keyboard, and the like, for operating the browsing server device 3, and reference numeral 33 denotes a display portion that displays status information on the browsing server device 3, etc.

Reference numeral 34 denotes an electronic data recording processing portion that executes processing of recording electronic date for Web browsing (electronic data to be transmitted) output from the electronic data registering portion 23 of the electronic data transmitting apparatus 1, on the HDD 35 (storing the electronic data in the HDD 35).

The HDD 35 records, for example, electronic data for Web browsing.

Reference numeral 36 denotes a request processing portion that transmits display information on the electronic data to the client PC in responds to a request from a client PC for browsing electronic data recorded on the HDD 35.

Reference numeral 37 denotes a control portion that controls each of the function blocks.

The processing of multi-casting of data executed by the electronic data transmitting apparatus 1 will be described in detail.

When a user selects electronic data to be transmitted recorded on the HDD 17, the electronic data attribute information detecting portion 25 detects attribute information (security level) set in the electronic data to be transmitted.

The transmission method determining portion 26 refers to the detected attribute information, the address attribute information table 50, and the transmission rule table 51, and determines a transmission method of electronic data for each address so as to accord with a transmission rule for each address (see FIG. 1C).

For example, when setting additional information (color/single(1)-page layout printing) on electronic data is determined as the transmission method of electronic data for each address, the electronic data additional information setting portion 15 sets additional information of color/single(1)-page layout printing in the electronic data to be transmitted. In other words, when the transmission method determining portion 26 determines to provide additional information (color/single(1)-page layout printing) with the electronic data as a transmission method when transmitting the electronic data, the electronic data is transmitted with the determined additional information to each address via multi-casting.

Subsequently, the electronic data transmitting/receiving portion 14 is instructed to transmit the electronic data with the additional information set thereon by the electronic data additional information setting portion 15. Upon receiving the instruction, the electronic data transmitting/receiving portion 14 creates an e-mail massage including the electronic data with the additional information set thereon to transmit the e-mail via multi-casting to the corresponding addresses.

When Web browsing is determined as the transmission method, the electronic data registering portion 23 of the electronic data transmitting apparatus 1 outputs electronic data to be transmitted for Web browsing, to the browsing server device 3.

When receiving the electronic data to be transmitted, the electronic data recording processing portion 34 of the browsing server device 3 records the electronic data to be transmitted in the HDD 35 (stores the electronic data in the HDD 35).

At the same time, the electronic data registering portion 23 of the electronic data transmitting apparatus 1 records storage place information (URL) of the electronic data on the storage place information recording portion 24.

Subsequently, the transmission method determining portion 26 does not transmit the electronic data itself but acquires the storage place information (URL) of the electronic data from the storage place information recording portion 24, and instructs the electronic data transmitting/receiving portion 14 to transmit an e-mail including the storage place information. Receiving the instruction, the electronic data transmitting/receiving portion 14 creates an e-mail massage including the URL of a place of storage of the electronic data to transmit the e-mail via multi-casting to the corresponding addresses.

A user who received the e-mail including the URL of the storage place, is able to browse the electronic data by accessing the URL through a browser, and the like.

In a case of transmitting an e-mail as described above, information on a transmission method determined by the transmission method determining portion 26 may be added to the text (body) of the e-mail.

For example, an explanation sentences, such as “Click URL in the e-mail text, and you can browse electronic data”, is added to the text.

Additional information set by the electronic data additional information setting portion 15 may be added to the text of the e-mail.

For example, explanation sentences, such as “Attached electronic data is printable in color” and “Attached electronic data is editable”, are added to the text.

This improves convenience for a receiver.

When not transmitting electronic data (electronic data is not transmitted) is determined, the electronic data is not transmitted to the corresponding address.

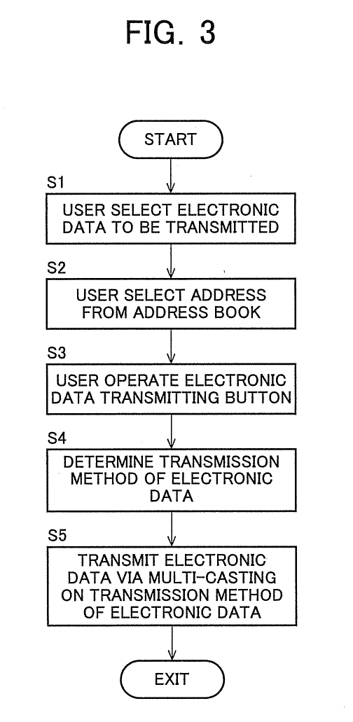

The detail of the above transmission method of electronic data will then be described referring to a flowchart of FIG. 3.

A user selects electronic data to be transmitted recorded on the HDD 17 through the operation portion 12 (step S1), and then selects an address from the address book included in the HDD 17 (step S2).

Subsequently, when an electronic data transmitting button of the operation portion 12 is operated (step S3), the transmission method determining portion 26 refers to a security level detected by the electronic data attribute information detecting portion 25, the address attribute information table 50, and the transmission rule table 51, and determines a transmission method of electronic data for each address so as to accord with a transmission rule for each address (step S4).

Based on the transmission method of electronic data determined at step S4, the transmission method determining portion 26 then instructs the electronic data transmitting/receiving portion 14 to transmit electronic data (e-mail) for each address. The transmitting/receiving portion 14 thus transmits the electronic data via multi-casting, based on the instruction (step S5).

When Web browsing is determined as the transmission method at step S4, an e-mail including the URL of a place of storage of the electronic data is transmitted via multi-casting.

An e-mail including information on a determined transmission method may be transmitted via multi-casting at the same time when electronic data with additional information set thereon and an e-mail including the URL of a place of storage of electronic data are transmitted.

A user, and the like, is allowed to change a transmission rule on the transmission rule table 51 through the operation portion 12.

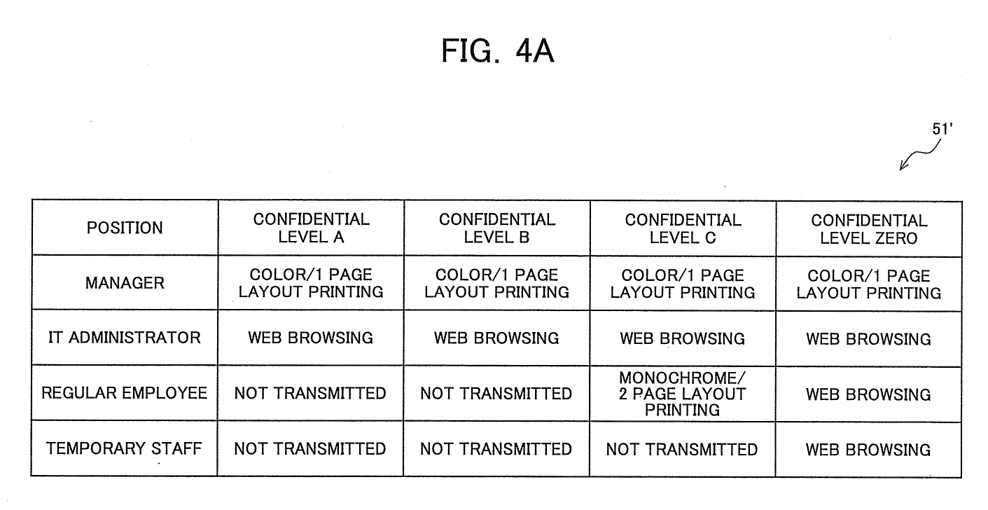

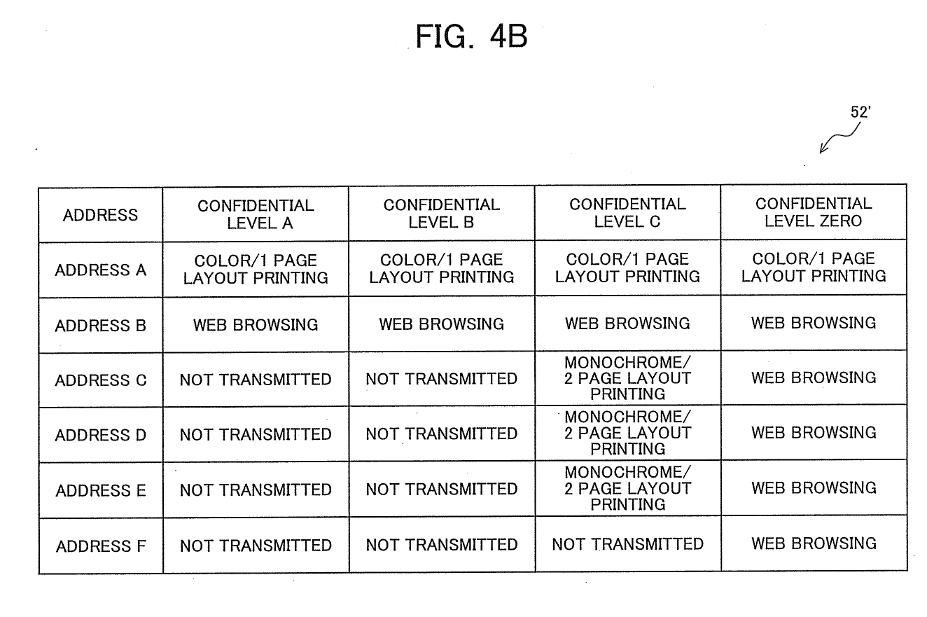

For example, if a transmission rule for data with a confidential level C to a regular employee is changed from “Web browsing” to “monochrome/two(2)-page layout printing”, as shown on a transmission rule table 51′ of FIG. 4A, methods of transmission of electronic data for a regular employee are changed all together, as shown on a transmission table 52′ of FIG. 4B.

In this manner, transmission methods for respective addresses can be changed all together by just changing a transmission rule. This improves convenience for the user.

### Second Embodiment

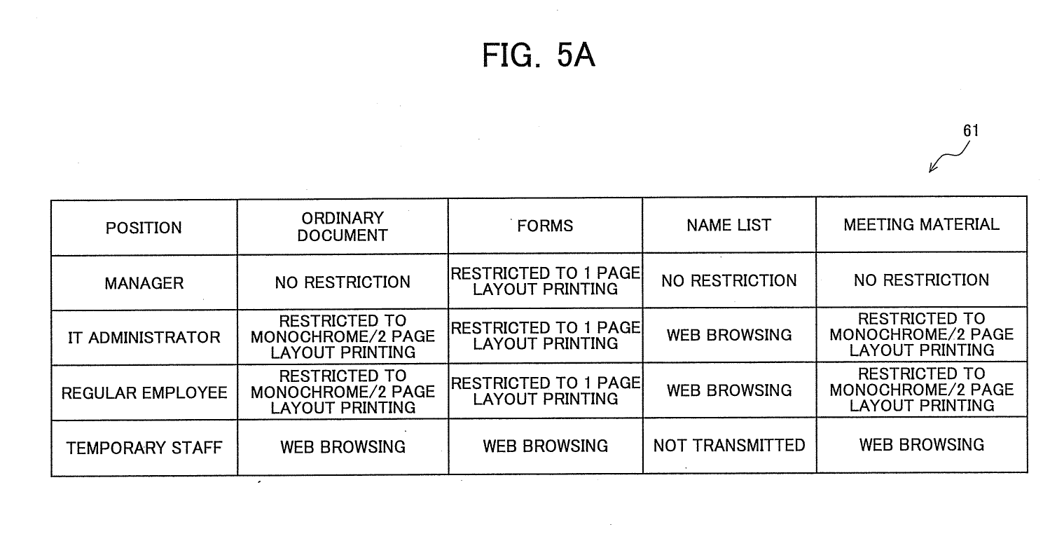

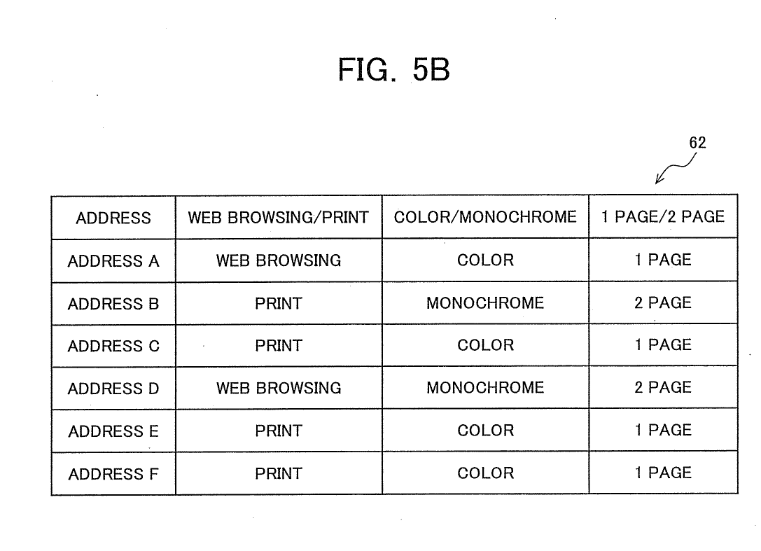

While a security level is described as an example of attribute information of electronic data in the first embodiment, the contents of electronic data other than the security level, such as forms, name list, and meeting material, may also be preset as attribute information of the electronic data. In this case, transmission rules as shown on a transmission rule table 61 of FIG. 5A are recorded.

As shown on a specifying table (separate transmission rule table) 62 of FIG. 5B, a printing method, and the like, may be specified in advance by a receiver (address) who received electronic data.

For example, a certain receiver always specifies to be able to permit the receiving data in color and single(1)-page layout printing. Another receiver specifies to receive but not print electronic data so as only to be able to browse the electronic data on the Web site. The specifying table 62 is recorded on the transmission rule recording portion 22.

The electronic data transmitting apparatus 1 transmits electronic data in accordance with the specification of a receiver under a restriction of a transmission rule.

For example, when the transmitting device transmits electronic data with attribute information “ordinary document” set thereon to an address A (a manager), the transmission method determining portion 26 determines “Web browsing” as a transmission method in conformity with the specifying table 62 because “no restriction” is recorded for an ordinary document for a manager on the transmission rule table 61, while “Web browsing” is specified on the specifying table 62.

When the electronic data is transmitted to the address C (regular employee), setting “monochrome/two(2)-page layout printing” in the electronic data as additional information is in association with the transmission rule table 61, because “printing/color/single(1)-page layout” is specified for the address C according to the specifying table 62, while “restricted to monochrome/two(2)-page layout printing” is recorded for an ordinary document for a regular employee according to the transmission rule table 61.

After this, an e-mail is transmitted via multi-casting based on determined transmission methods, as described above.

As shown in a transmission rule table 63 of FIG. 5C, a transmission rule table 61 of FIG. 5A and a separate transmission rule table) 62 of FIG. 5B may be combined.

In this manner, a reduction in printing members can be achieved because a printing method can be set in electronic data as additional information when the electronic data is transmitted in a case where color printing, regular printing (single(1)-page layout printing), and the like, must be restricted in order to reduce costs (TCO) spent for printing members, such as printing papers and toner, and maintenance of a computer system.

Since single(1)-page layout printing is set in advance for such documents as forms that are easy to see when printed in single(1)-page layout, convenience for the receiver is improved. In addition, since a printing method, and the like, can be specified in advance, convenience for the receiver is improved.

### Third Embodiment

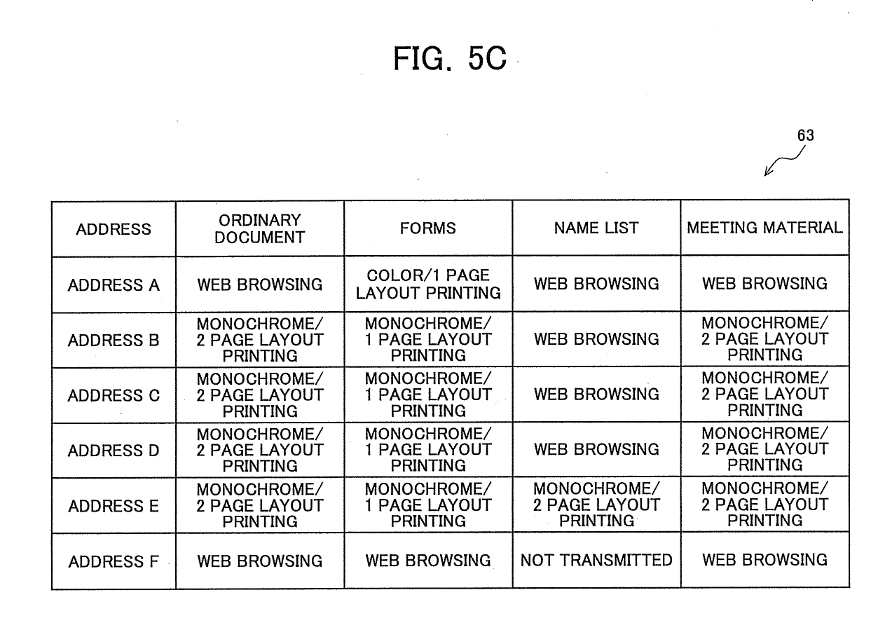

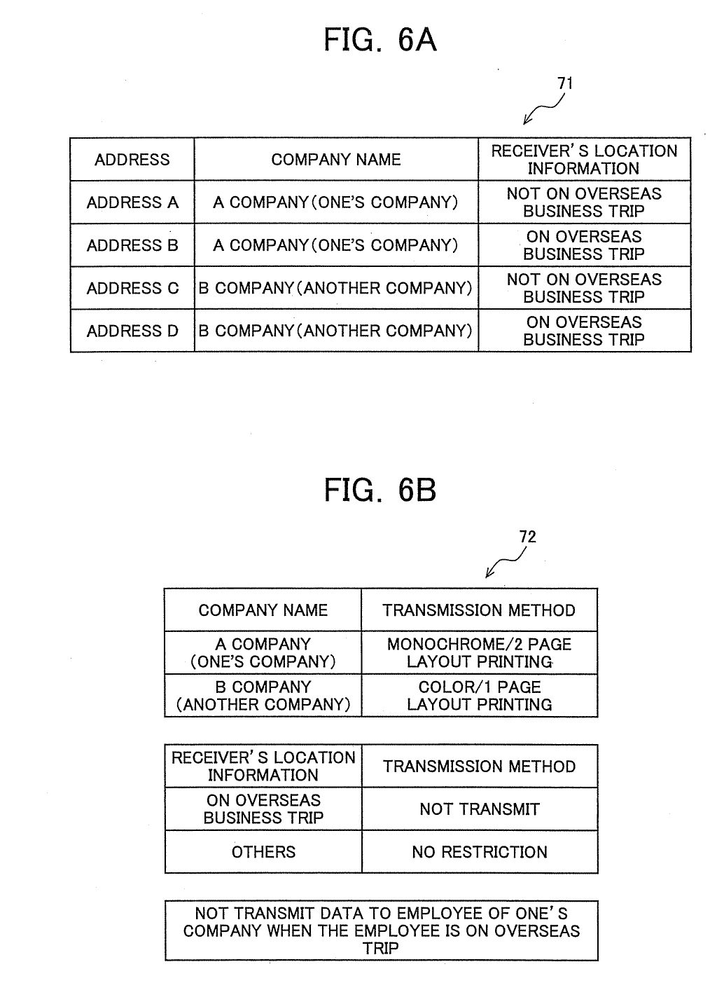

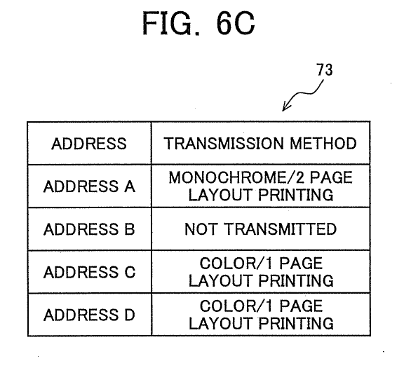

While a name of title (employee of one's company), which is the attribute of an address, is described as attribute information of the address in the first and second embodiments, an employee of another company who is a receiver who receives electronic data and an employee's present location information may also be recorded as attribute information of an address, as shown in FIG. 6A.

In FIG. 6A, A company is one's company while B company is another company.

When address attribute information is changed in this manner, transmission rules may be determined, for example, as shown on a transmission rule table 72 of FIG. 6B.

Because the A company (one's company) puts restriction on color printing and n-page layout printing to cut down TCO, monochrome/two(2)-page layout printing is set in advance as an electronic data printing method when data is transmitted to an employee of the A company (one's company).

The B company, which is another company, has no need to put restriction on a printing method, so that color/single(1)-page layout printing is set as a printing method.

Transmission methods vary depending on employee's present location information, and a rule is determined so that data is not transmitted to an employee of one's company when the employee is on an overseas business trip.

When the user specifies the addresses A to D and instructs the electronic data transmitting apparatus 1 of the present invention to transmit electronic data with a security level set thereon via multi-casting, the transmission method determining portion 26 of the transmitting device 1 refers to the address attribute information table 71 containing a plurality types of attribute information recorded thereon and the transmission rule table 72, and determines transmission methods of electronic data, as shown on a transmission table 73 of FIG. 6C.

After this, an e-mail is transmitted via multi-casting based on determined transmission methods, as described above.

### Fourth Embodiment

In another case, a plurality types of attribute information may be set in electronic data.

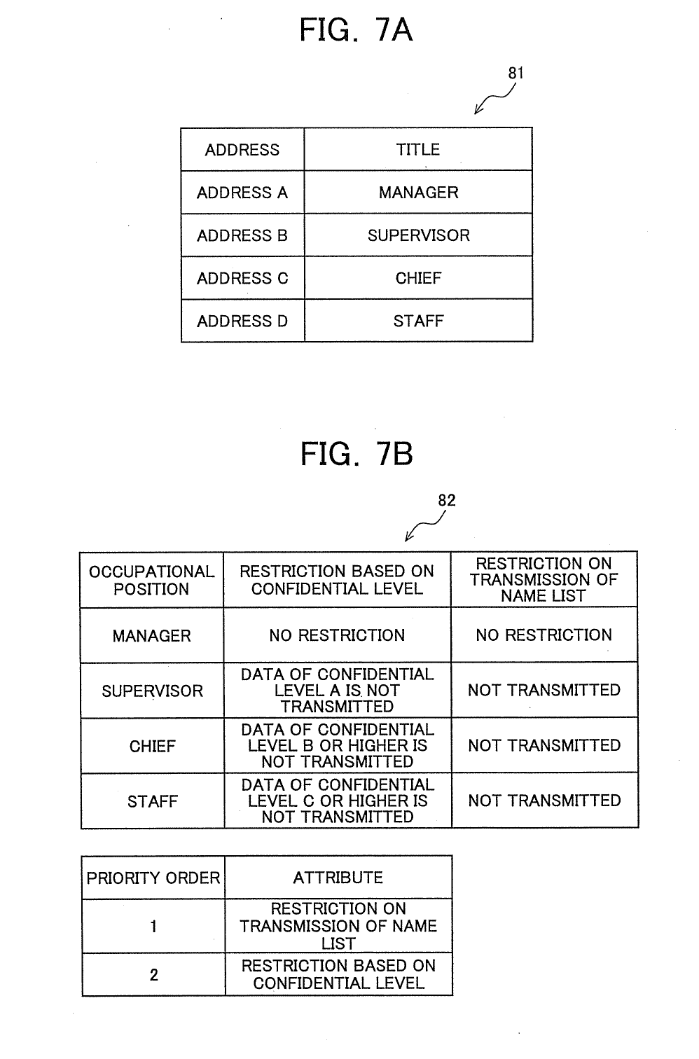

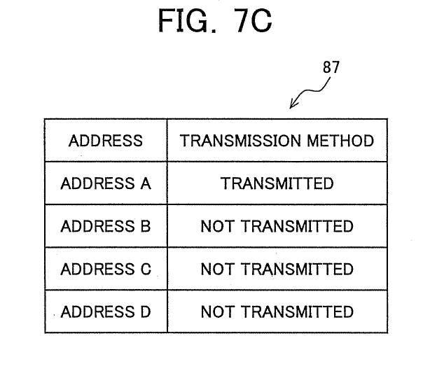

FIG. 7A shows another address attribute information table 81, and FIG. 7B shows an example of a transmission rule table 82.

For example, in a case of electronic data including such personal information as a name list, it is considered that the electronic data should not be transmitted to an employee whose title is subordinate to a predetermined title because even though a low security level is set in the electronic data, the electronic data includes personal information.

In such a case, as shown on the transmission rule table 82, a plurality types of attribute information, e.g., two types of information of “restriction based on a confidential level” and “restriction on transmission of a name list” are set in the electronic data, and which attribute information (restriction) is to be given priority is specified.

When the user specifies the addresses A to D and instructs the electronic data transmitting apparatus 1 of the present invention to transmit electronic data with a confidential level B and a name list as attribute information set thereon via multi-casting, the transmission method determining portion 26 of the transmitting device 1 refers to attribute information of the highest priority set in the electronic data, the address attribute information table 81, and the transmission table 82, and determines transmission methods of the electronic data, as shown on a transmission table 83 of FIG. 7C. After the determination, the electronic data transmitting/receiving portion 14 creates an e-mail massage based on a determined transmission method to transmit the e-mail to a predetermined address.

The electronic data is supposed to be transmitted also to the address B in conformity with a confidential-based rule, but because the document set as attribute information is a name list, the electronic data is actually transmitted only to the address A. “Not transmitted (not transmit)” is stronger in restrictive effect (higher in priority) than “no restriction”, so that even if the priority order of attributes and that of transmission rules are not determined, methods of transmission are the same as the transmission methods of the present embodiment.

### [Others]

The electronic data transmitting apparatus 1 and the browsing server device 3 may be integrated together. All pieces of electronic data to be transmitted may be stored in the HDD 35 of the browsing server device 3 to cause the browsing server device 3 to function as a document server device.

Other address attributes, such as a department to which one belongs, place of work, and relevant project, may be recorded on the address attribute table, or a plurality types of address attributes may be combined.

A purpose of use, effective period, and the like, may be recorded (stored) as additional information of electronic data, or a plurality types of additional information may be combined.

1. An electronic data transmitting apparatus having a function of multi-casting electronic data to each address comprising:
an address information recording table having a record of attribute information of the address for each address;
a transmission rule table having a record of a transmission rule for the electronic data in association with the attribute information of the address, and attribute information preset to the electronic data; and
a transmission method determining portion that determines a transmission method for electronic data by referring to the attribute information preset to the electronic data, the address information recording table, and the transmission rule table, when the electronic data is transmitted to any of addresses recorded on the address information recording table via multi-casting, wherein
the electronic data is transmitted via multi-casting based on the determined transmission method.

2. The electronic data transmitting apparatus as defined in claim 1, comprising:
a server device that stores the electronic data and allows a user to browse the electronic data upon receiving a browsing request from the user; and
a recording portion that records information of a place of storage of the electronic data stored in the server device, wherein
when the transmission method determining portion determines Web browsing as a transmission method of electronic data for each address, the information of the place of storage of the electronic data is transmitted to each address instead of electronic data.

3. The electronic data transmitting apparatus as defined in claim 2, wherein
the server device has a document server function for storing therein all pieces of electronic data to be transmitted or a browsing server function for allowing a user to browse the electronic data to be transmitted in response to a browsing request from the user.

4. The electronic data transmitting apparatus as defined in claim 1, wherein
when the transmission method determining portion determines to provide additional information with the electronic data as a transmission method when transmitting the electronic data, the electronic data is transmitted with the determined additional information to each address via multi-casting.

5. The electronic data transmitting apparatus as defined in claim 4, wherein
the additional information is a method of printing the electronic data.

6. The electronic data transmitting apparatus as defined in claim 4, wherein
the additional information is information of permission/nonpermission of editing the electronic data.

7. The electronic data transmitting apparatus as defined in any one of claims 1 to 6, wherein
the electronic data is attached to an e-mail and the e-mail is transmitted to each address via multi-casting.

8. The electronic data transmitting apparatus as defined in claim 7, wherein
information on the determined transmission method and the additional information are added to a text of the e-mail and the e-mail is transmitted to each address via multi-casting.

9. The electronic data transmitting apparatus as defined in any one of claims 1 to 6, wherein
the attribute information of the address is information of the present location of an electronic data receiver.

10. An electronic data transmitting method executed by an electronic data transmitting apparatus having: an address information recording table having a record of attribute information of each address; a transmission rule table having a record of a transmission rule for the electronic data in association with the attribute information of the address for each address, and attribute information preset to the electronic data; and a function for multi-casting electronic data to each address, the method comprising steps of:
when electronic data is transmitted via multi-casting to any of addresses recorded on the address information recording table,
referring to the attribute information preset to the electronic data, the address information recording table, and the transmission rule table;
determining a transmission method of the electronic data; and
transmitting the electronic data to each address via multi-casting in accordance with the determined transmission method.
